(19) United States
(12) Patent Application Publication
(10) Pub. No.: US 2010/0021753 A1
(43) Pub. Date: Jan. 28, 2010

(54) MULTIZONE WOOD POLYMER COMPOSITE ARTICLE

(75) Inventors: Sassan Hojabr, Kingston (CA); Christopher Michael Barr, Harpers Ferry, WV (US); Penny L. Perry, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/509,176

(22) Filed: Jul. 24, 2009

Related U.S. Application Data
(60) Provisional application No. 61/083,687, filed on Jul. 25, 2008.

(51) Int. Cl. B32B 23/04

(52) U.S. Cl. 428/507; 428/534; 428/532; 264/211

(57) ABSTRACT

Disclosed are articles and multi-zoned structures comprising a core zone comprising a wood polymer composition comprising a blend of cellulosic material and a thermoplastic polymeric resin; a cap zone disposed overlying at least a portion of the core zone comprises at least a portion of a surface of the multi-zoned structure; and, optionally, a transition zone disposed between the cap zone and the core zone. The articles are useful as wood polymer composites for use as planks, decking, stair treads, window casings, fencings, automobile interiors and pallets.

This application claims priority to U.S. provisional application No. 61/083,687, filed Jul. 25, 2008; the entire disclosure of which is incorporated herein by reference.

This invention relates to a wood polymer composite article comprising a core zone comprising a composition with little or no ionomer and a cap zone comprising a composition containing an ionomer.

### BACKGROUND

With the rising cost of wood and the shortage of mature trees, it is desirable to find substitutes for wood. A growing market has emerged for the use of wood polymer composites (WPCs) to replace traditional wood products, including pressure-treated lumber in applications such as decking, window casing, fencing, automobile interiors and pallets. WPCs typically consist of mixtures of thermoplastic materials with cellulose, such as wood particles in the form of sawdust. WPCs may be used in many of the same applications as an all-wood product but offer advantages of providing flame resistance, as well as enhanced resistance to rot, resistance to attack by insects, and resistance to deterioration due to the effects of moisture and sunlight. WPCs may have the same workability as wood, may be splinter-free, and may be capable of being colored in bulk as opposed to wood, which typically can only be surface stained or painted.

Generally, WPC decking is made from cellulosic fiber composites with polyethylene. Alternatives to polyethylene-containing WPC include polyvinyl chloride (PVC) WPC. See, e.g., U.S. Pat. Nos. 6,011,091, 6,066,680, and 6,103,791. See also US Patent applications 2003/0229160, 2003/021915, and 2005/0187315. U.S. Pat. No. 4,480,061 describes ionomer-wood flour compositions and articles made therefrom.

In general, consumers prefer WPC over pressure-treated lumber and want products having extended lifetimes (for example, at least for 25 years) with minimal maintenance.

Current WPC products offer significant advantages over pressure-treated lumber for maintenance over the life of the product. However, WPC products are subject to the same environmental factors, including staining, scuffing, scratching, marring and fading as pressure treated lumber, so it is desirable to limit the susceptibility of the WPC to those factors. Most of these issues relate to the surface of the WPC and not the bulk of the material. There have been attempts to modify the surface of WPCs such as the use of surface or cap layers over a bulk or core WPC layer. Previous surface layers include an acrylonitrile-styrene-acrylate surface or cap layer (see US Patent Application Publications 2006/0147693 and 2008/0128933) and use of a coating applied on the surface of the WPC (e.g. special paint). US Patent Application Publication 2005/194585 describes wood articles made from wood substrates (i.e. natural wood, pressure treated wood, or laminated wood) and ionomers cross head extruded onto the wood substrate. When a coating has been used, the surface of the WPC frequently required pretreatment to allow the application of the coating layer.

### SUMMARY OF THE INVENTION

This invention relates to a multizoned wood composite article comprising:

(i) a core zone comprising a wood polymer composition comprising, consisting essentially of, or produced from a blend of cellulosic material and a thermoplastic polymeric resin that has little or no (less than 5 weight %, less than 1 weight %, or less than 0.1 weight %) ethylene acid copolymer ionomer; and

(ii) a cap zone disposed overlying at least a portion of the core zone and that comprises at least a portion of a surface of the multizoned wood composite article; wherein the cap zone comprises, consists essentially of, or is produced from a cap zone composition comprising a polymeric combination and optionally cellulosic material; wherein the polymeric combination comprises or consists essentially of an ionomer and a nonionomeric resin; wherein the ionomer comprises an ethylene acid copolymer having copolymerized units of ethylene, copolymerized units of at least one C₃ to C₈ α,β-ethylenically unsaturated carboxylic acid, and optionally copolymerized units of one or more alkyl (meth)acrylates wherein greater than 30% of the carboxylic acid moieties of the ethylene acid copolymer are neutralized to salts of alkali metal cations, transition metal cations, or alkaline earth metal cations, or combinations of two or more thereof; and the nonionomeric thermoplastic resin comprises an ethylene homopolymer or copolymer of ethylene with at least one α-olefin; wherein the concentration of the cellulosic material is greater in the core zone wood polymer composition than in the cap zone composition, when cellulosic material is present in the cap zone.

An embodiment is the article wherein the cap zone composition comprises about 10 to about 30 weight of cellulosic material.

A particular embodiment is the multizoned article wherein the cap zone composition comprises, consists essentially of, or is produced from:

(1) about 70 to about 90 weight %, based on the total of (1) and (2), of a polymeric combination comprising
(a) from about 50 weight % to about 80 weight %, based on the combination of (a) and (b), of the ionomer disclosed above; and
(b) from about 20 weight % to about 50 weight %, based on the combination of (a) and (b), of an ethylene homopolymer or copolymer of ethylene with at least one other α-olefin; and

(2) about 10 to about 30 weight %, based on the total of (1) and (2), of cellulosic material.

This invention also provides the above-described cap zone composition, which is useful for preparing a wood polymer composite article.

Another embodiment is the multizoned article comprising a transition zone disposed between the core zone and the cap zone; wherein the transition zone comprises, consists essentially of, or is produced from a transition zone composition comprising a polymeric combination with a concentration of ionomer which is less than the concentration of ionomer in the cap zone composition.

Embodiments include articles such as stain resistant, scuff resistant, scratch resistant and mar resistant planks, decking, stair treads, window casing, fencing, automobile interiors and pallets.

Compositions useful for WPC according to embodiments of the disclosure have workability using conventional construction techniques, including screwing, nailing, cutting, drilling, etc. Desirably, these materials may be fastened to structural materials with screws or nails without the need for drilling. The materials also have sufficient mechanical strength and stiffness for the application. For example, decking and stair treads need to be capable of supporting people and furniture without sagging when used in standard construction techniques.

Another aspect may include compositions that are lighter in weight than natural or pressure-treated lumber. Minimal water absorption is also desirable. The compositions desirably may be offered in various colors, with a natural feel and appearance.

### DETAILED DESCRIPTION OF THE INVENTION

Trademarks are shown in upper case. The entire disclosures of all references referred to herein are incorporated by reference. Unless stated otherwise, all percentages, parts, ratios, etc., are by weight. Further, when an amount, concentration, or other value or parameter is given as either a range or a list of upper values and lower values, this is to be understood as specifically disclosing all ranges formed from any pair of any upper range limit or preferred value and any lower range limit or preferred value, regardless of whether ranges are separately disclosed. It is not intended that the scope of the invention be limited to the specific values recited when defining a range. When a component is listed as an optional component in a composition or copolymer, it may not be present (it comprises 0%) or it may be present in a non-zero amount (such as at least 0.1%).

The term “(meth)acrylic acid” indicates methacrylic acid and/or acrylic acid. Likewise, the term “(meth)acrylate” indicates methacrylate and/or acrylate.

The term “polyethylene” refers to any of the ethylene homopolymers and copolymers of ethylene and alpha-olefins described below.

The term “zone” refers to an area or region of the WPC wherein the composition of the WPC varies in composition as compared to the adjacent area or region. Such a zone can be of uniform composition, or it can contain a region of varying or a gradient of composition such as increasing and/or decreasing in concentration of particles, type of particles, and/or size of particles, or composition of polymeric material. Zones can be defined or zones can overlap to further define a gradient. For example, zones can be a core zone, a cap zone, a transition zone, an overlapping zone or zones, and/or an exterior zone.

In an exemplary embodiment, a rectangular WPC may include a core zone, a cap zone and a transition zone between the core zone and the cap zone. In this embodiment, when taking a rectangular cross-section of the WPC, the cap zone encircles the core zone along at least one side of the core zone with a transition zone intermediate to (between) the core zone and cap zone. The composition of the WPC includes varying content of thermoplastic polymer resin, cellulosic fiber and ionomeric material. Gradient composition varies over the distance from a center area of the core zone to a center area of the cap zone. Gradients on each of the ingredients on a concentration basis are as follows as a function of distance from the center area of the core zone.

With respect to the thermoplastic polymeric resin in this embodiment at a center area of the core zone, the thermoplastic polymeric resin is present in a concentration between a maximum concentration and a minimum concentration for the thermoplastic polymeric resin. The concentration of the thermoplastic polymeric resin increases to a maximum thermoplastic polymeric resin concentration for the WPC in an area at or near the interface between the transition zone and the core zone. The concentration of the thermoplastic polymeric resin decreases from the core zone to the cap zone along the transition zone. At the center of the transition zone, the thermoplastic polymeric resin concentration is between the minimum and maximum concentrations and continues to decrease along the distance from the core zone through the interface between the transition zone and the cap zone and reaches a minimum concentration at an area at or near the center of the cap zone. The above represents an exemplary gradient based upon the concentration of single component, thermoplastic polymeric resin. With respect to the cellulosic fiber in this embodiment at a center area of the core zone, the cellulosic fiber is present in a maximum concentration for the WPC. The concentration of the cellulosic fiber decreases in concentration in an area near the interface between the transition zone and the core zone. The concentration of the cellulosic fiber decreases from the core zone to the cap zone along the transition zone. At the center of the transition zone, the cellulosic fiber concentration is between the minimum and maximum concentrations and continues to decrease along the distance from the core zone through the interface between the transition zone and the cap zone and reaches a minimum concentration at an area at or near the center of the cap zone. The above represents an exemplary gradient based upon the concentration of single component, cellulosic fiber.

With respect to the ionomeric material in this embodiment at a center area of the core zone, the ionomeric material is present in a minimum concentration for the WPC. The concentration of ionomeric material at the center area of the core zone may be zero. The concentration of the ionomeric material increases in concentration in an area near the interface between the transition zone and the core zone. The concentration of the ionomeric material increases from the core zone to the cap zone along the transition zone. At the center of the transition zone, the ionomeric material concentration is between the minimum and maximum concentrations of ionomeric material in the WPC and continues to increase along the distance from the core zone through the interface between the transition zone and the cap zone and reaches a maximum concentration at an area at or near the center of the cap zone. Alternatively, it is noted that ionomeric material may include maximum concentrations at the surface of the cap zone, depending on processing. The above represents an exemplary gradient based upon the concentration of single component, ionomeric material.

The above described gradient compositions may provide, for example, increased resistance to delamination as well as variable properties, including desirable properties at various distances from the center of the core zone through the transition zone and through the cap zone.

It is noted that while the above exemplary embodiment has been described on the basis of composition concentration, the disclosure is not so limited and other compositional aspects, such as variable particle size, across the zones of the WPC may be provided in the gradient composition.

While the above has been described with respect to three zones, the WPC of the present disclosure may include only two zones, such as a core zone and cap zone, having gradient composition between them.

When used as a cap or surface zone over a core WPC zone, a composition comprising or produced from an ionomeric material, such as an ethylene acid ionomer (an “ionomer-containing composition”) provides desired surface properties and may potentially lower the cost of WPC materials such as decking by reducing the need for expensive ingredients (e.g. color concentrate) in the bulky core zone.

The ionomer-containing composition may provide at least one of improved stain resistance, improved resistance to fading over time, and improved scuff scratch and mar resistance compared to known WPCs. Preferably, the cap zone has low gloss levels to maintain a “wood composite look”. When mixed with wood particles, the resulting composition also maintains the benefits of known WPC surfaces by maintaining low gloss levels with minimal changes to current processing practices. The ionomer-containing composition also exhibits improved modulus of rupture and improved modulus of elasticity (closer to that of pressure-treated lumber) compared to known WPCs.

The ionomer-containing composition used in the cap zone comprises an ionomer of an ethylene acid copolymer having copolymerized units of ethylene, copolymerized units of at least one C₃-C₈ α,β-ethylenically unsaturated carboxylic acid, and optionally copolymerized units of an alkyl (meth)acrylates wherein the alkyl groups have from 1 to 8, or 1 to 4, carbon atoms, the weight percentage of copolymerized units of the unsaturated carboxylic acid in the ethylene acid copolymer can be from about 3 to about 35 weight %, based on the weight of the ethylene acid copolymer, and greater than about 30 weight % of the carboxylic acid moieties of the ethylene acid copolymer may be neutralized to salts containing one or more alkali metal, transition metal, or alkaline earth metal cations.

The acid copolymers may be described as E/X/Y copolymers where E represents copolymerized units of ethylene, X represents copolymerized units of at least one a,p-ethylenically unsaturated carboxylic acid, and Y represents copolymerized units of a softening comonomer. “Softening” means that the crystallinity is disrupted (the polymer is made less crystalline). Notable are E/X/Y copolymers wherein Y is 0 weight % of the polymer (that is, an E/X dipolymer). When present, Y is present in at least about 0.1 weight % of the E/X/Y copolymer, preferably about 2 to about 35 weight % of the E/X/Y copolymer.

Examples of X include one or more of acrylic acid, methacrylic acid, maleic acid, maleic acid monoester, fumaric acid, or itaconic acid.

Examples of softening comonomers for use as Y include one or more alkyl (meth)acrylates, alkyl methacrylates, or combinations thereof.

Ethylene acid copolymers described above may be produced by any methods known to one skilled in the art such as use of “co-solvent technology” disclosed in U.S. Pat. No. 5,028,674 or by employing somewhat higher pressures than those at which copolymers with lower acid levels may be prepared.

Specific acid copolymers include ethylene/acrylic acid dipolymers, ethylene/methacrylic acid dipolymers, and ethylene/acrylic acid/n-butyl acrylate, ethylene/methacrylic acid/n-butyl methacrylate, ethylene/acrylic acid/iso-butyl acrylate, ethylene/methacrylic acid/iso-butyl methacrylate, ethylene/acrylic acid/methyl acrylate, ethylene/methacrylic acid/methyl methacrylate, ethylene/acrylic acid/ethyl acrylate terpolymers, and ethylene/methacrylic acid/ethyl methacrylate terpolymers, or combinations of two or more thereof.

Other acid copolymers include ethylene/maleic acid and ethylene/maleic acid monoester dipolymers; and ethylene/maleic acid monoester/n-butyl (meth)acrylate, ethylene/maleic acid monoester/methyl (meth)acrylate, ethylene/maleic acid monoester/ethyl (meth)acrylate terpolymers, or combinations of two or more thereof.

Ionomers are ionic copolymers that are obtained after neutralization of an acid copolymer. Neutralizing agents, which for the purposes of this application are basic compounds containing metal cations such as sodium, zinc, lithium, magnesium or potassium ions, are used to neutralize at least some portion of the acidic groups in the acid copolymer. Suitable ionomers are prepared from the acid copolymers described above by methods known in the art of preparing ionomers, such as those described in U.S. Pat. No. 3,264,272.

The level of neutralization, for example, may range from a lower limit of about 30, to an upper limit of about 40 percent, about 50, about 60, about 70, about 80, about 90, or about 100, based on the total carboxylic acid content, with a metallic ion. For example, neutralization levels may be about 30 to about 70%. The metallic ions may be monovalent, divalent, trivalent, multivalent, or combinations of two or more thereof. Examples include Li, Na, K, Cu, Mg, Ca, Fe, Co, Zn, and combinations of two or more thereof. If the metallic ion is multivalent, a complexing agent, such as stearate, oleate, salicylate, and phenolate radicals may be included, as disclosed in U.S. Pat. No. 3,404,134. Preferred cations include Na, Zn, or combinations thereof. Most preferred are zinc cations.

The composition for the cap zone optionally also includes polyethylene homopolymers or polyethylene copolymers wherein units derived from ethylene comprise the major portion or percentage by weight of the copolymer. By major portion or percentage is meant about 70 weight %, about 80 weight % or more of the copolymer. Examples of polyethylene copolymers are copolymers of ethylene and alpha-olefins, including copolymers with propylene and other alpha-olefins, wherein copolymerized units of ethylene comprise the major portion of the copolymer.

Suitable polyethylene homopolymers and polyethylene copolymers include linear polyethylenes such as high density polyethylene (HDPE), linear low density polyethylene (LLDPE), very low or ultralow density polyethylenes (VLDPE or ULDPE), branched polyethylenes such as low density polyethylene (LDPE), and copolymers of ethylene and alpha-olefin monomers prepared in the presence of metallocene catalysts, single site catalysts or constrained geometry catalysts (herein referred to as metallocene polyethylenes, or MPE). The densities of PE suitable for use in the composition range from about 0.865 g/cc to about 0.970 g/cc.

Polyethylene homopolymers and copolymers may be prepared by a variety of methods. Examples of such processes include, but are not limited to, the well-known Ziegler-Natta catalyst polymerization process (see for example U.S. Pat. Nos. 4,076,698 and 3,645,992), metallocene catalyzed polymerization, VERSIPOL single-site catalyst polymerization and free radical polymerization. The term metallocene catalyzed polymerization includes polymerization processes that involve the use of metallocene catalysts as well as those processes that involve use of constrained geometry and single-site catalysts. Polymerization may be conducted as a solution-phase process, a gas phase-process and the like. Polyethylenes used in the compositions described herein may be obtained from recycled material.

Examples of linear polyethylenes include ethylene copolymers having copolymerized units of alpha-olefin comonomers such as butene, hexene or octene. Suitable alpha-olefins may be selected from the group consisting of alpha-olefins having at least three carbon atoms, preferably from 3 to 20 carbon atoms. These comonomers may be present as copolymerized units in an amount of up to about 20 weight % or 30 weight % of the copolymer. Preferred alpha-olefins include propylene, 1-butene, 1-hexene, 4-methyl-i-pentene, 1-octene, 1-decene, 1-tetradecene and 1-octadecene. Copolymers may be obtained by polymerization of ethylene with two or more alpha-olefins, preferably including propylene, 1-butene, 1-octene and 4-methyl-1-pentene.

Also contemplated for use as the polyethylene component are blends of two or more of these ethylene alpha-olefin copolymers as well as mixtures of an ethylene homopolymer and one of the suitable ethylene alpha-olefin copolymers.

Polyethylene homopolymers and copolymers as described above may provide significantly reduced surface gloss compared to compositions containing ionomers as the only polymeric material. Inclusion of polyethylene may also provide improved service temperature. When the cap zone composition contains ionomer and polyethylene, preferably the ionomer is the continuous matrix phase. Use of polyethylene in the cap zone composition may also reduce its cost, particularly when recycled material is used. Cap zone compositions including ionomer, polyethylene and cellulosic material (see below) may include recycled production scrap.

Polyethylene homopolymers and copolymers as described above may also be included in the cap zone composition to provide increased adhesion of the cap zone composition to the core zone composition, or alternatively to any transition zones positioned between the cap zone and the core zone. Inclusion of polyethylene in the cap zone may be particularly useful when the core zone or transition zone includes polyethylene or other low polarity polymeric materials. When present in the ionomer-containing cap zone composition, polyethylene comprises from about 0.1 weight % to about 50 weight % of the combination of ionomer and polyethylene, preferably about 15 to about 45 weight %. The ratio of ionomer to polyethylene in the total composition may be about 1.2:1 to about 4:1.

Optionally, about I0 to about 30 weight %, based on the total weight of the composition, of cellulosic material may be used in the cap zone of the ionomer-containing composition. Cellulosic material may be used in the cap zone to provide an appearance more like a natural wood product, including lower gloss.

One (or more) cellulosic material may be used such as those obtained from wood and wood products, such as wood pulp fibers; non-woody paper-making fibers from cotton; straws and grasses, such as rice and esparto; canes and reeds, such as bagasse; bamboos; stalks with bast fibers, such as jute, flax, kenaf, cannabis, linen and ramie; and leaf fibers, such as abaca and sisal; paper (including recycled paper) or polymer-coated paper. Preferably the cellulosic material used is from a wood source. Suitable wood sources include softwood sources such as pines, spruces, and firs, and hardwood sources such as oaks, maples, eucalyptuses, poplars, beeches, and aspens. The form of the cellulosic materials from wood sources may be sawdust, wood chips, wood flour, or the like.

In addition to sawdust, agricultural residues and/or waste may be used. Agricultural residues are the remainder of a crop after the crop has been harvested. Examples of such suitable residues include residues from the harvesting of wheat, rice, and corn, for example. Examples of agricultural waste can include straw; corn stalks; rice hulls; wheat; oat; barley and oat chaff; coconut shells; peanut shells; walnut shells; jute; hemp; bagasse; bamboo; flax; and kenaff, and combinations thereof.

The cellulosic materials may be screened through various screens, e.g., a 30-mesh or a 40-mesh screen, to obtain materials of a specified size, or a mixture of different sizes may be used. The size of the cellulose material used may range from about 10 to about 100 mesh or about 40 to about 100 mesh.

The wood flours include soft and hard woods and combinations thereof. Preferable wood flours are oak and pine, available as OAK 4037 (40 mesh) and PINE 402050 (40 mesh), respectively from American Wood Fibers of Schofield, Wis. Maple wood flour may also be used.

The composition may additionally comprise conventional additives used in WPCs including plasticizers, compatibilizers or coupling agents, flexomers, stabilizers including viscosity stabilizers and hydrolytic stabilizers, antioxidants, ultraviolet ray absorbers, anti-static agents, dyes, pigments or other coloring agents, inorganic fillers, fire-retardants, lubricants, reinforcing agents such as glass fiber and flakes, foaming or blowing agents, processing aids, antiblock agents, release agents, pest repellants, and/or mixtures thereof. Optional additives, when used, may be present in various quantities so long as they are not used in an amount that detracts from the basic and novel characteristics of the composition, including good adhesion to the other layers of the WPC article, and at least one of reduced staining, scuffing, scratching, marring, and fading.

A suitable compatibilizing copolymer (compatibilizer, also referred to as coupling agent) may function to couple various components of the wood composite by covalent chemical bonding, and/or may change the chemical environment of the wood composite such that all of the components in the mixture are dispersed to form a stable composite. These compatibilizers may be present in an amount of from about 0.1 to about 10, about 0.1 to about 5, or about 1 to about 4, weight % based on the total weight of the composition.

Compatibilizers include maleic anhydride graft copolymers. Maleic anhydride-grafted polymers (maleated polymers) are polymeric materials in which maleic anhydride is reacted with an existing polymer, often under free-radical conditions, to form anhydride groups appended to the polymer chain. They include maleated polyethylene, maleated polypropylene, maleated styrene-ethylene-butene-styrene triblock copolymer, and maleated polybutadiene. General discussions of anhydride coupling agents in wood composites can be found in: “Effectiveness of Functionalized Polyolefins as Compatibilizers for Polyethylene/Wood Flour Composites,” Y. Wang, F. C. Yeh, S. M. Lai, H. C. Chan, and H. F. Shen in Polym. Eng. and Sci. April 2003, vol. 43, n.4, p. 933; and, “Surface of Cellulosic Materials Modified with Functionalized Polyethylene Coupling Agents”, Q. Li and L. M. Matuana in J. of Appl Polym Sci., (2003) vol. 88, p. 278.

Other suitable compatibilizers comprise ethylene copolymerized with a functional comonomer comprising an ethyleneically unsubstituted dicarboxylic acid or derivative thereof, selected from the group consisting of maleic anhydride; itaconic anhydride; maleic acid diesters; fumaric diesters; maleic acid monoesters or fumaric acid monoesters, including esters of C₁ to C₄ alcohols, such as, for example, methyl, ethyl, n-propyl, isopropyl, and n-butyl alcohols; maleic acid, itaconic acid; fumaric acid; or mixtures of any of these. The functional comonomer can be maleic anhydride, or monoesters and/or diesters of maleic acid. The copolymers may also comprise a third comonomer selected from the group consisting of vinyl acetate, acrylic acid, methacrylic acid, alkyl acrylate and methyl acrylate.

These compatibilizing copolymers can be obtained directly from the monomers by a high-pressure free radical polymerization process, described, for example, in U.S. Pat. No. 4,351,931. In contrast to graft copolymers such as the maleated polymers described above, portions of the units derived from the functional comonomers form part of the polymer chain and are not appended to a pre-existing chain.

Exemplary embodiments include articles and multi-zoned structures wherein the cap zone further comprises a compatibilizer selected from the group consisting of maleated polyethylene, maleated polypropylene, maleated styrene-ethylene-butene-styrene triblock copolymer, maleated polybutadiene, and ethylene copolymers wherein ethylene is copolymerized with a functional comonomer selected from the group maleic anhydride; itaconic anhydride; maleic acid diesters; fumaric diesters; maleic acid monoesters or fumaric acid monoesters, including esters of C₁ to C₄ alcohols, such as, for example, methyl, ethyl, n-propyl, isopropyl, and n-butyl alcohols; maleic acid, itaconic acid; fumaric acid; or mixtures of any of these. An example of coupling agent is an ethylene copolymer where ethylene is copolymerized with a maleic acid monoester.

The cap zone may be adhered directly to the core zone, as described below.

The core zone may comprise one or more thermoplastic polymers such as, for example, polyolefins such as HDPE, LDPE, LLDPE, ultrahigh molecular weight polyethylene (UHMWPE), ULDPE, copolymers of ethylene and a second α-olefin monomer including MPE, ethylene/propylene copolymers, terpolymers such as EPDM, and polypropylene homo- and copolymers. Such thermoplastic polymers may also include polymers and copolymers such as polyvinyl chloride, polyvinyl chloride vinyl acetate copolymers, polyvinyl chloride n-butyl acrylate copolymers, chlorinated polyvinyl chloride, and polystyrene. The thermoplastic polymeric resin used in the core zone has little or no (less than 5 weight %, less than 1 weight %, or less than 0.1 weight %) ethylene acid copolymer ionomer.

The thermoplastic polymer may comprise at least one ethylene copolymer, comprising copolymerized units of ethylene and copolymerized units of at least one polar comonomer. The copolymerized units of the polar comonomer may be present in the range of about 5 to about 50%, or about 10 to about 19%, or about 12 to about 15%, of the copolymer weight. A polar comonomer may include vinyl acetate, alkyl acrylate, alkyl methacrylate or combinations of two or more thereof, based on the total weight of the ethylene copolymer. The alkyl group may contain up to about 20 carbon atoms (preferably about 1 to about 8 or about 1 to about 4 carbon atoms) such as methyl, ethyl, butyl, isobutyl, pentyl, hexyl, and combinations of two or more thereof.

Examples of such polar comonomers include methyl acrylate, ethyl acrylate, methyl methacrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, 2-hydroxyethyl methacrylate, vinyl acetate, vinyl propionate, and combinations of two or more thereof.

An ethylene copolymer as described above may also comprise up to about 35 weight % of an optional comonomer such as carbon monoxide, sulfur dioxide, acrylonitrile, maleic anhydride, dimethyl maleate, diethyl maleate, dibutyl maleate, dimethyl fumarate, diethyl fumarate, dibutyl fumarate, dimenthyl fumarate, glycidyl acrylate, glycidyl methacrylate, glycidyl vinyl ether, or combinations of two or more thereof.

For example, the composition of the core zone may comprise from about 1 to about 30 weight % of at least one E/W/Z copolymer wherein E comprises ethylene; W is a monomer selected from the group consisting of vinyl acetate, alkyl acrylic esters and alkyl methacrylate esters; and Z is one or more optional comonomers disclosed above; W is from about 0 to about 50 weight % of the E/W/Z copolymer, Z is from about 0 to about 35 weight % of the E/W/Z copolymer, wherein the weight % of W and Z cannot both be 0, and E being the remainder. Preferably the combination of W and Z does not exceed about 50 weight % of the E/W/Z copolymer.

Examples of ethylene copolymers include, but are not limited to, ethylene/vinyl acetate (EVA), ethylene/methyl acrylate (EMA), ethylene/ethyl acrylate (EEA), ethylene/butyl acrylate (EBA), ethylene/isobutyl acrylate (EIBA), ethylene/methyl acrylate/maleic anhydride, ethylene/glycidyl methacrylate (EGMA), ethylene/butyl acrylate/glycidyl methacrylate (EBAGMA), ethylene/butyl acrylate/carbon monoxide (EBACO), and combinations of two or more thereof.

Examples of commercially available ethylene copolymers include those available from E. I. du Pont de Nemours and Company (DuPont), Wilmington, Del., carrying the trademarks of APPEEL, BYNEL, ELVALOY, and ELVAX.

Such ethylene copolymers may be produced by any means known to one skilled in the art using either autoclave or tubular reactors (e.g., U.S. Pat. Nos. 3,404,134, 5,028,674, 6,500,888, and 6,518,365).

About 50 to about 60 weight % of wood or cellulosic material may be included in compositions used for the core zone. The core zone may also comprise conventional additives as described above.

Of note are articles wherein the particle size distribution of the cellulosic material in the core zone and the cap zone are dissimilar. The multizone wood polymer composite article may optionally include a transition zone disposed between the cap zone and the core zone, in which one side of the transition zone is adhered to the cap zone and the opposite side is adhered to the core zone. The transition zone may comprise, consist essentially of, or produced from a transition zone composition comprising a polymeric combination with a concentration of ionomer which is less than the concentration of ionomer in the cap zone composition.

The transition zone may optionally include cellulosic material. When the transition zone includes cellulosic material, the concentration of cellulosic material in the transition zone composition may be intermediate between the concentration in the cap zone and the concentration in the core zone. The transition zone preferably has a gradient concentration of cellulosic material, thermoplastic polymer resin and ionomer; wherein the composition of the transition zone near the interface with the cap zone is more similar to the composition of the cap zone. The composition then varies as a gradient until the composition at the interface of the core zone is similar to that of the core zone.

Of note is an article wherein the transition zone comprises a maximum concentration of ionomer proximate to an area adjacent to the cap zone. Also of note is an article wherein the transition zone comprises a minimum concentration of ionomer proximate to an area adjacent to the core zone.

Inclusion of a transition zone may substantially prevent delamination of the cap zone from the core zone, or loss of adhesion between adjacent zones. “Delamination” is the separation of adjacent layers with application of little or no peeling force.

The compositions may be formed into shaped articles using methods such as injection molding, compression molding, overmolding, lamination, extrusion coating, coextrusion, profile coextrusion and the like.

Cast sheets comprising a core zone composition may be prepared by extrusion of the molten thermoplastic composition through a slot die. The thickness of the extrudate may be adjusted by the use of calendaring rolls and the extrudate may be quenched with chill rolls. Sheets may also be prepared by coextrusion of the core zone and a cap zone of the composition. In coextrusion, the core composition and the surface composition are melted in separate extruders and the molten compositions are passed through a slot die in a laminar flow.

Profiles are defined by having a particular shape and by their process of manufacture known as profile extrusion. Profiles are not film or sheeting, and thus the process for making profiles does not include the use of calendaring or chill rolls. Profiles are also not prepared by injection molding processes. Profiles are fabricated by melt extrusion processes that begin by extruding a thermoplastic melt through an orifice of a die forming an extrudate capable of maintaining a desired shape. The extrudate is typically drawn into its final dimensions while maintaining the desired shape and then quenched in air or a water bath to set the shape, thereby producing a profile. For example, the edges of the shaped article may be prepared with a specific contour. In some cases the shaped article may be prepared with voids running in the machine direction of the profile extrusion. These voids may allow for the preparation of thicker articles with reduced weight. As in cast sheet coextrusion, profiles may be prepared by passing a laminar flow of the surface composition and the core composition through the profile die.

In alternate embodiments, a film or sheet comprising the surface composition may be applied to a substrate comprising the core zone. For example, the composition may be applied as a coating or a laminate to a shaped article such as a sheet, board, plank or the like comprising the core zone composition.

The cap zone may be applied to a sheet or profile comprising the core zone by (co)extrusion coating or by lamination. For example, extrusion coating the cap zone material onto the core zone may be done as follows: The cap zone composition is melted in an extruder and passed through a flat die to form a molten curtain of the surface composition. The molten curtain drops onto the moving substrate to be immediately pressed onto that substrate and quenched by a quench drum. Coextrusion coating may be conducted similarly, except that an additional composition is melted in an extruder and the additional zone and the cap zone are passed through the slot die in a laminar flow.

A film of the cap zone material may also be laminated to a core zone substrate by means of an inner zone applied in molten form to adhere the film to the substrate. The process may involve laying down a molten curtain of the inner zone between the film and the substrate moving at high speed as they come into contact with a cold (chill) roll. The melt curtain can be formed by extruding the inner zone through a flat die.

The articles may be cut, injection molded, compression molded, overmolded, laminated, extruded, milled or the like to provide the desired shape and size to produce commercially usable products. The resultant product may have an appearance similar to wood and may be sawed, sanded, shaped, fastened and/or finished in the same manner as natural wood. It may be resistant to rot and decay as well as termite attack and may be used as a replacement for natural wood, for example, as decking, decorative moldings inside or outside of a house, railroad ties, picture frames, furniture, railings, window moldings, window components, door components, roofing systems, sidings, or other types of structural members. Although not intending to be bound by theory, it is believed that the properties are in part attributable to the formation of the zones. The following examples are to illustrate the invention.

### EXAMPLES

### Materials Used

I-1: An ionomer prepared from an ethylene/methacrylic acid (MAA) dipolymer containing 15 weight % of MAA, partially neutralized with Zn, with MI of 0.75 g/10 min.
I-2: E/MAA dipolymer, 15 weight % MAA, partially neutralized with Na cations, with MI of 0.9 g/10 min.
I-3: 1:1 blend of I-1 and I-2.
I-4: E/MAA dipolymer, 9 weight % MAA, partially neutralized with Zn cations, with MI of 4.5 g/10 min.
I-5: E/MAA dipolymer, 19 weight % MAA, partially neutralized with Zn cations, with MI of 4.5 g/10 min.
I-6: E/MAA dipolymer, 10.5 weight % MAA, partially neutralized with Zn cations, with MI of 1.1 g/10 min.
HDPE-1: high density polyethylene with density of 0.958 g/cc and MI of 0.95 g/10 min.
HDPE-2: high density polyethylene with density of 0.96 g/cc and MI of 4.7 g/10 min.
LDPE-1: A low density polyethylene and MI less than 1.0 g/10 min.
Fillers: 40 mesh wood flour derived from maple, oak and/or pine sources. Wood flour was dried at least 16 hours prior to compounding.
Coupling Agent 1: An ethylene/ethyl hydrogen maleate (maleic acid monoester) copolymer having 90.5 weight % of E and 9.5 weight % of EHM with MI of 30.
Board 1: Commercially available polyethylene (PE) based wood composite decking with 50-60 weight % of wood fiber.
Board 2: Commercially available polyvinyl chloride (PVC) cellular decking product without wood fibers.

The ionomers were compounded with polyethylene (HDPE), wood fibers and optional coupling agents according to the procedures below.

Lubricants were used when WPC with high wood content was compounded to be used as the core zone. Lubricants were added at 3 weight % of the composition if wood fiber content was over 50 weight % of the composition. For example, GLYCOLUBE WP2200 (available from Lonza) was used in high-wood-content compositions.

Coupling agents were also used in the core zone composition where the wood fiber content was over 50 weight %. They were added at about 1 to about 3 weight %. For example Coupling Agent-1, an ethylene/ethyl hydrogen maleate copolymer, was used.

### Processing

Compositions for use as the cap zone were prepared as described below and identified as described below.

### Extrusion Compounding

A Coporion W&P 25-mm twin screw extruder was used to compound the cap-zone compositions. A purge nitrogen flow was used. The polymeric components were pre-dried and blended to the throat of the extruder. Extruder screws were built to allow for melting/kneading of polymeric components prior to addition of pre-dried wood fibers through the side feeder. An air vent was used to remove the air introduced into the extruder with the wood flour. An intensive mixing zone was then used to properly mix the polymer melt with the wood fibers. A vacuum zone was placed closer to the end of the extruder to remove moisture and other off-gases from the product. Finally a pumping zone with short-pitch screw elements was employed to push the product through the die holes.

A Gala underwater pelletizing system was used to pelletize the extrudates into small pellet size. The overall rate was set at 8.0 kg/hr with screw speed of 200 rpm. The compositions were all then dried in an oven at 60° C. (140° F.) for at least 24 hours to remove any excess water before subsequent processing.

### Monolayer Cap-Layer Sheet Casting

A 1.25-inch Wayne single screw extruder with 24L/D was used to make monolayer films of the cap-zone. Extruder barrel temperatures were set to 150-170° C. (302-338° F.) when wood fibers were in the composition and from 180-200° C. (356-392° F.) in the absence of wood fibers. The extruder speed and the haul-off were adjusted to obtain the desired sheet thickness. For monolayer ionomer film without wood filler the sheet thickness was 5.0 mil, with a die gap setting of 10.0 mil. For cap layer compositions with 10 to 30 weight % wood, the films were 5 to 10 mil thick.

Cast films were prepared from the ionomer-containing compositions. These films were laminated to commercial wood composite boards. Samples of WPC boards were heated in an oven (about 10 minutes) so that the board surface temperature was about 100-120° C. (212-248° F.). Examples of ionomer-containing films were laid onto the grain side of the boards. The structures were placed face down on a preheated press and heated for 30 seconds (including 15-second manipulation time). Pressure (30 to 50 psi) was applied to the laid-up structures to form the cap zone on the boards. The temperature was increased from 100 to 150° C. (212-302° F.) in 10° C. (18° F.) increments.

Lamination with Glenro Flat Bed Laminator

The films were also laminated to ¼-inch, 3-inch-long cut WPC commercially available boards according to the following procedure. The WPC samples were preheated to 120° C. (248° F.) at 0.5 m/min and the films were then laminated to the WPC at a pressure of 20 psi at 140° C. (284° F.), 150° C. (302° F.), and 160° C. at a speed of 1 m/min.

### Co-Extrusion Casting and Formation of Cap and Core Zones

A second 1-inch single screw Davis extruder was used to extrude a cap-layer and a core layer was extruded with the Wayne extruder. The two layers were co-extruded using an adaptor block, fed with Wayne and Davis extruders. The adaptor block fed a six-inch coat hanger die set at 125 mil gap. The thickness for the core layer was set at 80 mils and the cap layer at 40 mils. For high wood content in the core layer (above 40 weight % wood filler) the gap was set at 125 mils and sheet thickness was 90-120 mils. The co-extruded cap layer and core layer formed a plurality of zones.

### Tandem Extrusion of Cap-layer Onto WPC Core Layer

Tandem Extrusion refers to extrusion of two separate layers joining right after the die, for example in a nip roll, which eliminates a long transfer line. The Wayne cast sheet line was set up with Wayne Extruder and a 6-inch die for the core layer while Hamilton extruder is set up with an 8-inch die for the cap-layer.
1-inch Diameter Davis (Hamilton) Standard—B Extruder
1.25-inch Diameter Wayne Extruder—C Extruder
6-inch Sheet Die—⅛ inch Die Gap (120 mil)
8-inch Sheet Die—10 mil Die Gap
8-inch Cast Film Unit
   The tandem-extruded cap layer and core layer formed a plurality of zones.

### Analytical Techniques

Melt flow index Melt flow Index was determined according to ASTM Method D 1238-E at 190° C. (374° F.), with 2.16 Kg mass.

Peel testing An INSTRON peel tester with a 10-lb load cell and cross speed of 2 inch/min at 180 peel angle was used to measure peel strength and failure mode.

Stain resistance A qualitative test was used to measure resistance against stains from common products such as coffee, vegetable oil, mustard, ketchup, grease, juice and red wine. The products were applied to the surface of the test piece and allowed to stand for a specified period and then the products were wiped and/or rinsed off the surface. Subsequently the stains were cleaned with a detergent and rated. A rating scale of 1-5 was used to show total stain removal (1) to permanent dark staining (5).

Ford Five Finger Test for scratch and mar (scuff) resistance These tests were conducted according to procedures available at http//www.directindustries.com/prod/taber-industries/scratch-mar-test-set-18732-57456.html. Tests with 5, 7, 10, 15 and 20N loading on the stylus were used. Scratch tests used a sharp stylus and mar tests used a rounded-tip stylus. Both scratch and mar were measured on a scale of 1 (no visible sign) to 5 (deep marks with material removal).

Gloss level measurement using 60° gloss meter Surface gloss was measured at 60° view angle in the machine and transverse directions and using a Gloss-meter according to ASTM procedures D2457 and D523.

Adhesion test Adhesion between the cap-layer and the core layer was assessed for samples “as made” and after subjecting to immersion in 23° C. water, boiling water and/or dry heat. The laminates were assessed visually for signs of delamination at the interface between the cap zone and the core zone.

For preliminary adhesion testing, films of ionomers (listed as I-1 through 1-4 in the “materials used” section) were examined and their blends without wood flour filler for use as the cap-layer is listed in Table 1.

5.0-mil film samples were cast as described in “Monolayer Cap-Layer Sheet Casting” section. The films were subsequently laminated to a PE-based WPC board as outlined in “Lamination with Glenro Flat Bed Laminator”. A lamination temperature of 160° C. (320° F.) was preferred to achieve adequate bonding.

The resultant structures were qualitatively evaluated for adhesion between the cap-zone and the core zone. The peel adhesion was measured after 12 hours of exposure to room temperature air (“as made”) and after 24 hours of immersion in water at about 23° C. (73.4° F.). Table 1 summarizes the results.

TABLE 1

| Example | Ionomer | 12 Hr | 24 hr immersion in water |
|---|---|---|---|
| 1 | I-4 | Bond | Barely able to pick off small pieces |
| 2 | I-4 | Bond | Barely able to pick off small pieces |
| 3 | I-1 | Bond | Barely able to pick off small pieces |
| 4 | I-3 | Bond | Able to start and peel edges |
| 5 | I-2 | Bond | Able to start and peel edges |

All Examples were laminated at 160° C., except that Example 1 was laminated at 150° C.

Sodium-containing ionomers showed greater tendency to delaminate after extended immersion. Visual inspection showed that the examples were very glossy.

### Addition of Wood Flour

Addition of wood flour to zinc-containing ionomers I-1, I-5 and I-6 was evaluated. The compositions, summarized in Table 2, were compounded in W&P twin screw extruder at an overall rate of 6 kg/hour with nitrogen on at throat and vent. Examples 6-11 and 18 were underwater pelletized. All others were strand cut. Gloss, scratch and stain resistance were measured. These samples also had high gloss.

TABLE 2

| | Ionomer | | | Wood Flour | | |
|---|---|---|---|---|---|---|
| Example | I-1 | I-5 | I-6 | Maple | Oak | Pine |
| 6 | 100 | — | — | | — | — |
| 7 | 97.5 | — | — | 2.5 | — | — |
| 8 | 95.0 | — | — | 5.0 | — | — |
| 9 | 90.0 | — | — | 10.0 | — | — |
| 10 | 80.0 | — | — | 20.0 | — | — |
| 11 | 95.0 | — | — | 5.0 | — | — |
| 12 | — | 97.5 | — | 2.5 | — | — |
| 13 | — | 95.0 | — | 5.0 | — | — |
| 14 | — | 90.0 | — | 10.0 | — | — |
| 15 | — | — | 97.5 | 2.5 | — | — |
| 16 | — | — | 95.0 | 5.0 | — | — |
| 17 | — | — | 90.0 | 10.0 | — | — |
| 18 | 95.0 | — | — | — | 5.0 | — |
| 19 | 95.0 | — | — | — | — | 5.0 |

### Lamination Trial

Monolayer films of selected compositions (shown below) were cast and subsequently laminated to ¼-inch, 6-inch-long cut commercial deck boards (Board 1) as described in “Lamination with Glenro Flat Bed Laminator”. Peel strength was measured as described using a 10-lb load cell and cross speed of 2 inch/min at 180° peel angle.

TABLE 3

| | Cap-Layer | | | |
|---|---|---|---|---|
| Example | Composition | Film (mil) | Peel Strength | Adhesion |
| 20 | Example 6 | 4.0 | Low | Separated by hand |
| 21 | Example 12 | 4.0 | Low | Separated by hand |

Lamination using this technique resulted in poor adhesion.

### Tandem Extrusion of Ionomer Cap-Layer Onto WPC Core Layer

Subsequently, selected samples of a zoned structure (cap and core) were extrusion-laminated using the tandem extrusion process. Two extruders and the Killion 8-inch wide cast roll were used. The core layer comprised 45 weight % of oak flour in LDPE at 125-mil thickness. Samples were also laminated to Board 1 samples using the “Lamination with Glenro Flat Bed Laminator” procedure. Compositions used in the cap layer are shown in Table 4.

TABLE 4

| | Cap layer | | Total Thickness |
|---|---|---|---|
| Example | Composition | Thickness (mil) | of structure (mil) |
| 22 | Example 8 | 5.0 | 130 |
| 23 | Example 9 | 5.0 | 130 |
| 24 | Example 10 | 5.0 | 130 |
| 25 | Example 15 | 5.0 | 130 |

The samples were evaluated in the 60° gloss test and the Ford 5-finger scratch test. Table 5 summarizes the results. The “L” designation is for laminated samples.

TABLE 5

| | 60° Gloss | | Scratch Test | | | | |
|---|---|---|---|---|---|---|---|
| Example | MD | TD | 2N | 5N | 7N | 10N | 15N |
| 22 | 67.3 | 62.85 | 2 | 3 | 4 | 5 | 5 |
| 23 | 49.25 | 40.95 | 1 | 1 | 1 | 1 | 2 |
| 23L | 31.9 | 26.95 | 1 | 1 | 1 | 2 | 3 |
| 24 | 16.7 | 11.6 | 1 | 1 | 2 | 2 | 4 |
| 24L | 33.25 | 15.4 | 1 | 2 | 2 | 3 | 4 |
| 25 | 35.6 | 27.75 | 1 | 1 | 1 | 2 | 4 |
| Board 1 | 2.4 | 2.3 | 1 | 2 | 2 | 3 | 3 |

Example 23, with 10 weight % maple wood content, had the best scratch rating, better than the commercial board. Example 24, with 20 weight % maple wood content, had the lowest gloss ratings, that were higher than commercial Board 1.

Stain tests were conducted on Example 24 with four common staining agents, i.e, ketchup, mustard, grease and oil. The results are summarized in Table 6.

TABLE 6

| | | Example 24 | | Commercial Board 1 | |
|---|---|---|---|---|---|
| Stain | Time¹ | Rating² | Comments | Rating² | Comments |
| Ketchup | 3 | 1 | No stain | 1 | No stain |
| | 72 | 1 | No stain | 1 | No stain |
| Mustard | 3 | 1 | No stain | 1 | No stain |
| | 72 | 1 | No stain | 2 | Slight yellow stain |
| Grease | 3 | 1 | Slight discoloration | 5 | Dark spot stain |
| | 72 | 1 | Slight discoloration | 5 | Dark spot stain |
| Oil | 3 | 2 | Slight discoloration | 4 | Medium/dark spot stain |
| | 72 | 2 | Slight discoloration | 5 | Dark spot stain |

¹Residence time before clean-up, in hours
²Stain rating in 1-5 scale

The stain resistance ratings were comparable to or better than the commercial standard.

### Peel Adhesion

The composition of Example 10 was extruded with a 45% wood filled PE core layer using the “Tandem Extrusion of Cap-layer onto WPC Core-Layer” procedure (similar to Example 24). The adhesion between the cap-zone and core-zone was measured using an INSTRON peel tester and the peel data are shown below.

TABLE 7

| Cap Layer Composition | 90° Peel Strength | Comments |
|---|---|---|
| Example 10 | 7.0 lb/inch | Barely able to initiate |
| | | peel, film tears with load |

### Extrusion Compounding, 2-Layer Co-Extrusion

The cap-layer compositions summarized in Table 8 below were compounded in a Coporion W&P 25 mm twin screw extruder. These compositions were a blend of ionomer, polyethylene and wood flour.

TABLE 8

| Example | HDPE-2 | I-1 | Oak wood Flour | Coupling Agent 1 |
|---|---|---|---|---|
| 26 | 30 | 55 | 15 | |
| 27 | 30 | 55 | 15 | |
| 28 | 20 | 60 | 20 | |
| 29 | 40 | 45 | 15 | |
| 30 | 30 | 50 | 20 | |
| 31 | 40 | 40 | 20 | |
| 32 | 30 | 60 | 10 | |
| 33 | 20 | 70 | 10 | |
| 34 | 30 | 55 | 15 | |
| 35 | 40 | 50 | 10 | |
| 36 | 20 | 65 | 15 | |
| 37 | 30 | 53 | 15 | 2 |
| 38 | 30 | 55 | 15 (Maple Wood Flour) | |

Subsequently the compounded pellets were dried and extruded over a 55% oak-filled PE core layer 30-50 mil in thickness according to the procedure described in “Co-Extrusion Casting and Formation of Cap and Core Zones”. Scratch and mar resistance, stain resistance, gloss and adhesion of cap to core zones were evaluated for these samples as below.

### Scratch and Mar Test

The samples were tested for scratch resistance (Table 9) and mar resistance (Table 10) using the Ford 5-Finger Test described above.

TABLE 9

| | Scratch Test (Rating 1-5) | | | | |
|---|---|---|---|---|---|
| Example | 5N | 7N | 10N | 15N | 20N |
| 26 | 1 | 2 | 2 | 2 | 3 |
| 27 | 1 | 2 | 2 | 3 | 3 |
| 28 | 1 | 1 | 1 | 2 | 3 |
| 29 | 2 | 2 | 3 | 3 | 4 |
| 30 | 1 | 2 | 2 | 3 | 4 |
| 31 | 2 | 2 | 3 | 3 | 4 |
| 32 | 1 | 1 | 2 | 2 | 3 |
| 33 | 1 | 1 | 1 | 2 | 3 |
| 34 | 1 | 2 | 2 | 3 | 3 |
| 35 | 2 | 2 | 3 | 3 | 4 |
| 36 | 1 | 1 | 1 | 3 | 3 |
| 37 | 1 | 1 | 2 | 2 | 3 |
| 38 | 1 | 1 | 2 | 2 | 3 |
| Board 1 | 2 | 2 | 3 | 3 | 4 |
| Board 2 | 2 | 2 | 2 | 3 | 3 |

Scratch at the highest load (20N) was represented mathematically as shown: Scratch (20N)=3.1+0.5(HDPE)+0.17(WF)+0.23(HDPE)²+0.23(WF)². This means lower HDPE and wood fiber content provided better scratch values (below 3.0).

TABLE 10

| | Mar Testing - Rate 1-5 | | | | |
|---|---|---|---|---|---|
| Example | 5N | 7N | 10N | 15N | 20N |
| 26 | 1 | 1 | 1 | 1 | 1 |
| 27 | 1 | 1 | 1 | 1 | 1 |
| 28 | 1 | 1 | 1 | 1 | 1 |
| 29 | 1 | 1 | 1 | 1 | 1 |
| 30 | 1 | 1 | 1 | 1 | 1 |
| 31 | 1 | 1 | 1 | 2 | 2 |
| 32 | 1 | 1 | 1 | 1 | 1 |
| 33 | 1 | 1 | 1 | 1 | 1 |
| 34 | 1 | 1 | 1 | 1 | 1 |
| 35 | 1 | 1 | 1 | 1 | 1 |
| 36 | 1 | 1 | 1 | 1 | 1 |
| 37 | 1 | 1 | 1 | 1 | 1 |
| 38 | 1 | 1 | 1 | 1 | 1 |
| Board 1 | 2 | 2 | 2 | 2 | 2 |
| Board 2 | 1 | 1 | 1 | 2 | 2 |

Mar Ratings were at 1 (no signs) for all samples except sample 6, which had high HDPE (40 weight %) and high wood fiber (20 weight %).

TABLE 11

| | Stain Testing - Rating 1-5 | | | | |
|---|---|---|---|---|---|
| | | | Vegetable Oil (Before/ | | |
| Example | Coffee | Ketchup | After Detergent Wash) | Mustard | Juice |
| 26 | 1 | 1 | 3/1 | 1 | 1 |
| 27 | 1 | 1 | 3/1 | 1 | 1 |
| 28 | 1 | 1 | 3/1 | 1 | 1 |
| 29 | 1 | 1 | 3/1 | 1 | 1 |
| 30 | 1 | 1 | 3/1 | 1 | 1 |
| 31 | 1 | 1 | 3/1 | 1 | 1 |
| 32 | 1 | 1 | 2/1 | 1 | 1 |
| 33 | 1 | 1 | 3/1 | 1 | 1 |
| 34 | 1 | 1 | 3/1 | 1 | 1 |
| 35 | 1 | 1 | 3/1 | 1 | 1 |
| 36 | 1 | 1 | 3/1 | 1 | 1 |
| 37 | 1 | 1 | 3/1 | 1 | 1 |
| 38 | 1 | 1 | 3/1 | 1 | 1 |
| Board 1 | 1 | 1 | 5/5 | 3/2 | 1 |
| Board 2 | 1-2 | 1 | 1 | 1 | 1-2 |

All samples showed some staining with vegetable oil, but the ratings after washing with detergent were 1, indicating no permanent staining.

Gloss Measurement Surface gloss was measured at 60° view angle in the machine (MD) and transverse directions (TD) as summarized in Table 12. Higher wood content resulted in lower gloss values. Using a matte finishing roll (covered with a fine sand paper instead of a polish roll) reduced the gloss value by greater than 50% (see the examples designated with “LG”). A coarser paper reduced the gloss by another 50%, as shown by Example 37CLG. Values around 2-3 were close to those of commercial non-glossy deck boards.

TABLE 12

| Example | MD Average | TD Average |
|---|---|---|
| 26 | 7.16 | 5.92 |
| 27 | 7.32 | 5.92 |
| 28 | 8.80 | 6.74 |
| 29 | 6.10 | 5.56 |
| 30 | 5.64 | 5.00 |
| 31 | 5.74 | 5.22 |
| 32 | 6.78 | 5.82 |
| 33 | 10.26 | 7.42 |
| 33LG | 3.82 | 3.42 |
| 34 | 6.94 | 5.72 |
| 34LG | 3.06 | 2.96 |
| 35 | 7.26 | 6.36 |
| 35LG | 2.94 | 2.90 |
| 36 | 10.02 | 7.54 |
| 36LG | 3.48 | 3.20 |
| 37 | 7.97 | 6.47 |
| 37LG | 2.93 | 2.90 |
| 38 | 6.73 | 5.97 |
| 38LG | 3.90 | 3.73 |
| 38CLG | 1.80 | 1.70 |
| Commercial Board 1 | 2.07 | 2.03 |
| Commercial Board 2 | 1.93 | 1.67 |

### Adhesion Test

None of samples from Table 8 showed any delamination between the cap zone and the WPC core zone when tested after 12 hours air exposure, after 24-hour immersion in 23° C. water bath or when immersed in boiling water for two hours.

While the disclosure has been described with reference to preferred embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A multizoned wood composite article comprising a core zone and a cap zone wherein
the core zone comprises a wood polymer composition comprising a blend of cellulosic material and a thermoplastic polymeric resin that has little or no ethylene acid copolymer ionomer;
the cap zone is disposed overlying at least a portion of the core zone and comprises at least a portion of a surface of the article;
the cap zone comprises a cap zone composition comprising an ionomer and optionally cellulosic material;
the ionomer comprises an ethylene acid copolymer having copolymerized units of ethylene, copolymerized units of at least one C₃ to C₈ α,β-ethylenically unsaturated carboxylic acid, and optionally copolymerized units of one or more alkyl (meth)acrylates wherein greater than 30% of the carboxylic acid moieties of the ethylene acid copolymer are neutralized to salts of alkali metal cations, transition metal cations, or alkaline earth metal cations, or combinations of two or more thereof, and
the concentration of cellulosic material, is greater in the core zone than in the cap zone, when cellulosic material is present in the cap zone.

2. The article of claim 1 wherein the cap zone composition further comprises a polyethylene wherein the polyethylene is a polyethylene homopolymer, a polyethylene copolymer of ethylene with at least one other α-olefin, or combinations thereof.

3. The article of claim 1 wherein the cap zone composition further comprises, based on the weight of the cap zone, about 10 to about 30 weight of cellulosic material.

4. The article of claim 2 wherein the cap zone further comprises, based on the weight of the cap zone, about 10 to about 30 weight of cellulosic material wherein the polyethylene is present in a combination of the polyethylene and the ionomer and the combination is present in the cap zone, based on the weight of the cap zone, from about 70 to about 90%.

5. The article of claim 4 wherein the polyethylene is present, based on the weight of the combination, from 0.1% to about 50%.

6. The article of claim 5 wherein the combination comprises, based on the weight of the combination, about 50 to about 80% of the ionomer and about 20% to about 50% of the polyethylene.

7. The article of claim 4 wherein the cap zone further comprises a compatibilizer wherein
the compatibilizer is selected from the group consisting of maleated polyethylene, maleated polypropylene, maleated styrene-ethylene-butene-styrene triblock copolymer, maleated polybutadiene, ethylene copolymer, and combinations of two or more thereof,
the ethylene copolymer is a copolymer of ethylene copolymerized with maleic acid, itaconic acid, fumaric acid, maleic anhydride, itaconic anhydride, fumaric anhydride, maleic acid diester, itaconic acid diester, fumaric diester, maleic acid monoester, itaconic acid monoester, fumaric acid monoester, or combinations of two or more thereof,
the ester has 1 to 4 carbon atoms.

8. The article of claim 7 wherein the compatibilizer comprises the ethylene copolymer.

9. The article of claim 6 wherein the cap zone further comprises a compatibilizer; the compatibilizer is an ethylene copolymer; and the ethylene is a copolymer of ethylene copolymerized maleic acid monoester.

10. The article of claim 6 wherein the article is a multilayer structure, plank, decking, stair tread, window casing, fencing, automobile interior, or pallet.

11. The article of claim 1 further comprising a transition zone disposed between the cap zone and the core zone, in which one side of the transition zone is adhered to the cap zone and the opposite side of the transition zone is adhered to the core zone.

12. The article of claim 6 further comprising a transition zone disposed between the cap zone and the core zone wherein
one side of the transition zone is directly adhered to the cap zone and the opposite side of the transition zone is adhered to the core zone;
the transition zone has a gradient concentration of the celluosic material, the polyethylene, and the ionomer;
the concentration of the cellulosic material is greater in the core zone than in the cap zone; and
the concentration of the polyethylene, the ionomer, or combinations thereof in the core zone is less than in the cap zone.

13. The article of claim 12 wherein the cap zone further comprises a compatibilizer wherein
the compatibilizer is selected from the group consisting of maleated polyethylene, maleated polypropylene, maleated styrene-ethylene-butene-styrene triblock copolymer, maleated polybutadiene, ethylene copolymer, and combinations of two or more thereof,
the ethylene copolymer is a copolymer of ethylene copolymerized with maleic acid, itaconic acid, fumaric acid, maleic anhydride, itaconic anhydride, fumaric anhydride, maleic acid diester, itaconic acid diester, fumaric diester, maleic acid monoester, itaconic acid monoester, fumaric acid monoester, or combinations of two or more thereof,
the ester has 1 to 4 carbon atoms.

14. The article of claim 7 wherein the compatibilizer comprises the ethylene copolymer.

15. The article of claim 13 wherein the transition zone comprises a maximum concentration of ionomer proximate to an area adjacent to the cap zone.

16. The article of claim 14 wherein the transition zone comprises a minimum concentration of ionomer proximate to an area adjacent to the core zone.

17. The article of claim 14 wherein the particle size distribution of the cellulosic material in the core zone and the cap zone are dissimilar.

18. The article of claim 14 wherein the article is a multilayer structure, plank, decking, stair tread, window casing, fencing, automobile interior, or pallet.

19. A planking, decking, or stair comprising or produced from a multizoned article wherein the article is as recited in claim 11.

20. A method comprising co-extruding a core zone composition and a cap zone composition to produce an article having a cap zone and a core zone and optionally converting the article for planking, decking, or stair wherein
the article is a multizoned wood composite article;
the co-extruding produces a gradient across the core zone and cap zone;
the core zone composition comprises a blend of cellulosic material and a thermoplastic polymeric resin that has little or no ethylene acid copolymer ionomer;
the cap zone is disposed overlying at least a portion of the core zone and comprises at least a portion of a surface of the article;
the cap zone composition comprises an ionomer and optionally cellulosic material;
the ionomer comprises an ethylene acid copolymer having copolymerized units of ethylene, copolymerized units of at least one C₃ to C₈ α,β-ethylenically unsaturated carboxylic acid, and optionally copolymerized units of one or more alkyl (meth)acrylates wherein greater than 30% of the carboxylic acid moieties of the ethylene acid copolymer are neutralized to salts of alkali metal cations, transition metal cations, or alkaline earth metal cations, or combinations of two or more thereof, and
the concentration of cellulosic material, is greater in the core zone than in the cap zone, when cellulosic material is present in the cap zone.

21. The method of claim 20 wherein the gradient forms a transition zone disposed between the cap zone and the core zone, in which one side of the transition zone is adhered to the cap zone and the opposite side of the transition zone is adhered to the core zone.
